(19) United States
(12) Patent Application Publication
(10) Pub. No.: US 2012/0086676 A1
(43) Pub. Date: Apr. 12, 2012

(54) ROTARY SWITCHING DEVICE AND FILE SEARCH SYSTEM USING THE SAME

(75) Inventor: Yong Ho Noh, Hwaseong (KR)

(73) Assignee: HYUNDAI MOTOR COMPANY, Seoul (KR)

(21) Appl. No.: 13/326,039

(22) Filed: Dec. 14, 2011

Related U.S. Application Data
(62) Division of application No. 12/326,395, filed on Dec. 2, 2008.

(30) Foreign Application Priority Data
Dec. 13, 2007 (KR) 10-2007-0129794

(51) Int. Cl. G06F 3/02

(52) U.S. Cl. 345/184

(57) ABSTRACT

The present invention features a rotary switching device and a file search system using the same. In preferred embodiments, the rotary switching device includes a rotary push button, a first switch part, second switch parts, a first contact part, and a second contact part.

### CROSS-REFERENCE TO RELATED APPLICATIONS

This application claims under 35 U.S.C. §119(a) priority to Korean Application No. 10-2007-0129794, filed on Dec. 13, 2007, the disclosure of which is incorporated herein by reference in its entirety.

### BACKGROUND OF THE INVENTION

1. Field of the Invention

The present invention relates generally to a rotary switching device having two operational modes and a file search system using the rotary switching device. More particularly, the present invention relates to a rotary switching device, which can be rotated in two operational modes, and a file search system, which can selectively search for files and folders using the rotary switching device.

2. Background Art

With the development of technology for personal electronic devices, for example, a notebook computer, a desktop computer, and an MPEG Layer-3 (MP3) player, various methods have been introduced in order to systematically search for document files or folders, which are recorded on or in a storage medium.

Generally, in the case where a command, which is used to search for a file contained in an arbitrary folder, is transmitted to an electronic device, the corresponding electronic device searches a storage medium for an address, which is assigned as a default address, and first displays folder or file information, which is present in the uppermost directory. However, in the case where a file, which is desired by a user, is not stored in the default directory, it is necessary to perform a separate search operation.

Particularly, in examples where various folders are arranged in an upper directory and a desired file is present in a corresponding folder in a subdirectory thereof, two search steps are required to search for the desired file, which can be inconvenient.

Accordingly, a device that is capable of separately performing suitable file searching in an upper folder and a lower folder has been introduced.

FIG. 1 is an exemplary view showing a conventional file search system. Referring to FIG. 1, folder search buttons 2, which are preferably used to search for folders, and a rotary knob 1, which is used to search for files, are preferably separately provided. Accordingly, when the folder search buttons 2 are selectively pressed, corresponding folder information is suitably displayed on an output unit 3. In contrast, when the rotary knob 1 is selected, corresponding file information is suitably output through the output unit 3. However, in the above-described conventional system, the individual manipulation buttons are suitably required to perform both a file search and a folder search, and manipulation may be inconvenient and costs may be increased.

The above information disclosed in this the Background section is only for enhancement of understanding of the background of the invention and therefore it may contain information that does not form the prior art that is already known in this country to a person of ordinary skill in the art.

### SUMMARY OF THE INVENTION

Preferred aspects of the present invention feature a rotary switching device, which can be suitably rotated in two operational modes, and a file search system, which can selectively search for files and folders using the rotary switching device.

In certain preferred embodiments, the present invention provides a rotary switching device having two operational modes, including, but limited to, a rotary push button configured to be suitably rotated both in a first mode and in a second mode, the first mode preferably being a mode in which the rotary push button is rotated in a state in which the rotary push button is not pushed, and the second mode preferably being a mode in which the rotary push button is rotated in a state in which the rotary push button is pushed; a first switch part provided in one region of the lower surface of the rotary push button; second switch parts provided in another region in the lower surface of the rotary push button; a first contact part brought into contact with the first switch part in the second mode 12, thus suitably generating a first operational signal; and a second contact part brought into contact with the second switch parts both in the first mode and in the second mode, thus suitably generating a second operational signal.

In other preferred embodiments, the first switch part may be suitably provided in the central region of the lower surface of the rotary push button. In still other embodiments, preferably, the second switch parts may be provided in the outer circumferential region of the lower surface of the rotary push button. In further embodiments, the second switch parts, which are preferably provided in the outer circumferential region of the lower surface of the rotary push button, may be suitably concentrically formed at regular intervals.

In further preferred embodiments, the second operational signal may be a square wave signal, which is suitably generated by the rotation of the rotary push button and is suitably configured to have a predetermined period.

In further preferred embodiments, the second contact part may be suitably fastened using a member having suitable elasticity so that the second contact part is preferably brought into contact with the second switch parts in the second mode.

In other embodiments, the present invention provides a file search system, including, but not limited to, a rotary switching device having two operational modes, the rotary switching device preferably comprising a rotary push button suitably configured to be rotated both in a first mode and in a second mode, the first mode preferably being a mode in which the rotary push button is rotated in a state in which the rotary push button is not pushed, and the second mode preferably being a mode in which the rotary push button is rotated in a state in which the rotary push button is suitably pushed; a first switch part preferably provided in one region of the lower surface of the rotary push button; second switch parts preferably provided in another region in the lower surface of the rotary push button; a first contact part preferably brought into contact with the first switch part in the second mode 12, thus suitably generating a first operational signal; and a second contact part brought into contact with the second switch parts both in the first mode and in the second mode, thus suitably generating a second operational signal; a control unit for performing a file or folder search command, which is recorded in a storage device, by preferably combining the first and second operational signals, and suitably generating resultant output information; and an output unit for suitably displaying the output information, which is suitably transmitted from the control unit.

In further preferred embodiments, the storage device may preferably be an external storage medium that is externally connected to the control unit.

### BRIEF DESCRIPTION OF THE DRAWINGS

The above and other objects, features and advantages of the present invention will be more clearly understood from the following detailed description taken in conjunction with the accompanying drawings, which are given hereinafter by way of illustration only, and thus are not limitative of the present invention, and wherein:

FIG. 1 is a view showing a conventional file search system;

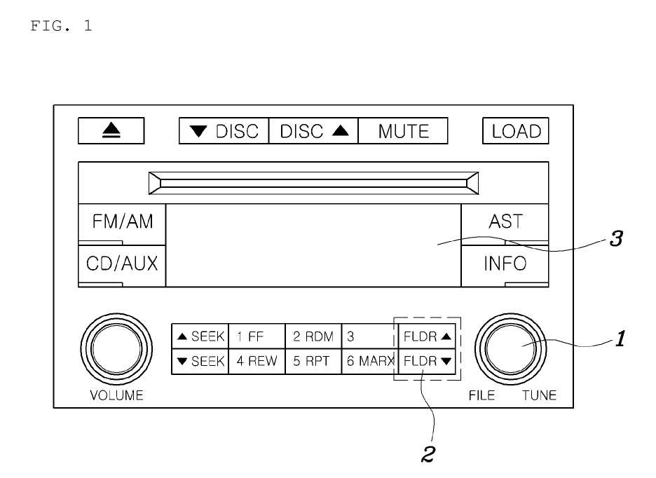

FIG. 2 is a view showing the construction of a rotary switching device, having two operational modes, according to the present invention;

FIG. 3 is a view illustrating the operational principle of the rotary switching device, having two operational modes, according to the present invention in a first mode;

FIG. 4 is a view illustrating the operational principle of the rotary switching device, having two operational modes, according to the present invention in a second mode; and

FIG. 5 is a conceptual block diagram showing a file search system using the rotary switching device, having two operational modes, according to the present invention.

### DESCRIPTION

As described herein, the present invention includes a rotary switching device having two operational modes, comprising a rotary push button configured to be rotated both in a first mode and in a second mode, a first switch part, second switch parts, a first contact part brought into contact with the first switch part in the second mode, thus generating a first operational signal, and a second contact part brought into contact with the second switch parts both in the first mode and in the second mode, thus generating a second operational signal.

In one embodiment, the rotary push button is configured to be rotated both in a first mode and in a second mode further comprises the first mode being a mode in which the rotary push button is rotated in a state in which the rotary push button is not pushed.

In another embodiment, the rotary push button is configured to be rotated both in a first mode and in a second mode further comprises the second mode being a mode in which the rotary push button is rotated in a state in which the rotary push button is pushed.

In a related embodiment, the first switch part is provided in one region of a lower surface of the rotary push button.

In another related embodiment, the second switch parts are provided in another region in the lower surface of the rotary push button.

In another aspect, the invention also features a file search system, comprising a rotary switching device having two operational modes, the rotary switching device comprising a rotary push button configured to be rotated both in a first mode and in a second mode, a first switch part, second switch parts, a first contact part brought into contact with the first switch part in the second mode, thus generating a first operational signal and a second contact part brought into contact with the second switch parts both in the first mode and in the second mode, thus generating a second operational signal, and a control unit for performing a file or folder search command, which is recorded in a storage device, by combining the first and second operational signals, and generating resultant output information.

In one embodiment, the first mode is a mode in which the rotary push button is rotated in a state in which the rotary push button is not pushed.

In another embodiment, the second mode is a mode in which the rotary push button is rotated in a state in which the rotary push button is pushed

In another related embodiment, the first switch part is provided in one region of a lower surface of the rotary push button.

In certain embodiments, the second switch parts are provided in another region in the lower surface of the rotary push button.

In related embodiments, the file search system further comprises an output unit for displaying the output information, which is transmitted from the control unit.

Preferred embodiments of the present invention are described in detail with the accompanying drawings below.

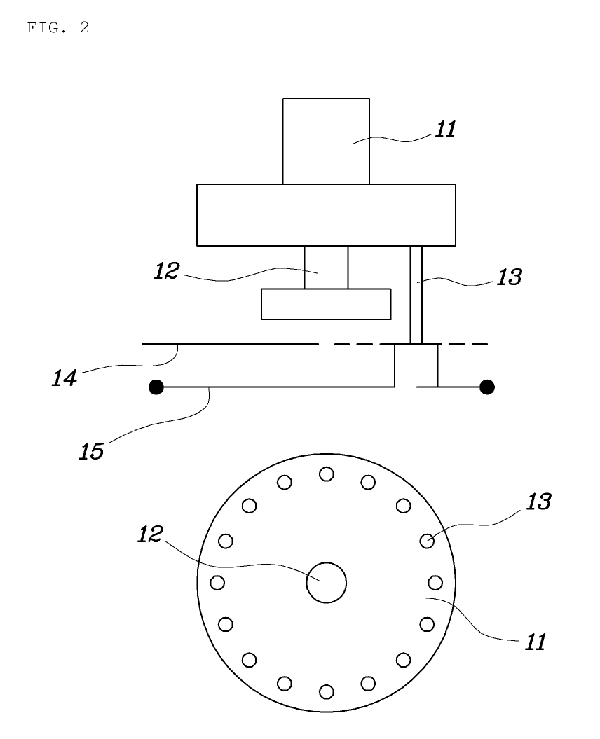

FIG. 2 is a view showing the construction of an exemplary rotary switching device, preferably having two operational modes, according to preferred embodiments of the present invention. Referring to FIG. 2, the rotary switching device 10, having two operational modes, according to exemplary embodiments of the present invention preferably includes a rotary push button 11, a first switch part 12, second switch parts 13, a first contact part 14, and a second contact part 15.

According to preferred embodiments of the invention as described herein, the rotary push button 11 is a rotary knob, and may be suitably rotated in two operational modes. In further embodiments, the rotary push button 11 is preferably rotated at an initial position in a first mode, but is rotated at a position at which it has been axially moved a suitably predetermined distance from the initial position in a second mode. As described above, the rotary push button 11 can be preferably rotated in two operational modes. In certain preferred exemplary embodiments, for example as described in the description given below wherein the term ‘first mode’ is preferably defined as a ‘mode’ in which the rotary push button 11 is suitably rotated in the state in which it is not pushed and that the term ‘second mode’ is defined as a ‘mode’ in which the rotary push button 11 is suitably rotated in the state in which it is pushed.

In certain preferred embodiments, when in the second mode, the first switch part 12 is preferably formed in the central region of the lower surface of the rotary push button 11, and is brought into suitable contact with the first contact part 14 when the rotary push button 11 is pushed.

Preferably, the second switch parts 13 are suitably formed in the outer circumferential region of the lower surface of the rotary push button 11, and are brought into contact with the second contact part 14 in the second mode as well as in the first mode. In certain preferred embodiments, the second switch parts are always brought into contact with the second contact part 14 in the second mode as well as in the first mode. In particular preferred embodiments, the second switch parts 13 may be suitably formed at regular intervals in the outer circumferential region of the lower surface of the rotary push button 11, as shown in exemplary FIG. 2.

Preferably, in the second mode, the first contact part is brought into contact with the first switch part 12, thus generating a first operational signal.

In other embodiments, the second contact part 15 is preferably brought into contact with the second switch parts in the second mode, as well as in the first mode, thus generating a second operational signal. In other particular embodiments, the second contact part 15 may be fastened using a member having suitable elasticity so that it can be brought into contact with the second switch parts 14 both in the first mode and in the second mode. For example, referring to FIG. 2, since the second switch parts 13 may be suitably formed at regular intervals in the outer circumferential region of the lower surface of the rotary push button 11, the second operational signal may be a square wave signal, which is suitably generated as an operational signal having a predetermined period.

In particular embodiments of the invention as described herein, the location and operation of the first switch part and the second switch parts 13, described above, may be suitably implemented in various ways. In particular, it is apparent that the first switch part 12 may be suitably formed in the outer circumferential region of the lower surface of the rotary push button 11 and that the second switch parts 13 may be suitably formed in the central region of the lower surface of the rotary push button 11. Furthermore, FIG. 2 shows a preferred embodiment of the present invention, and thus it will be apparent that the technical spirit of the present invention is not limited to the construction of FIG. 2.

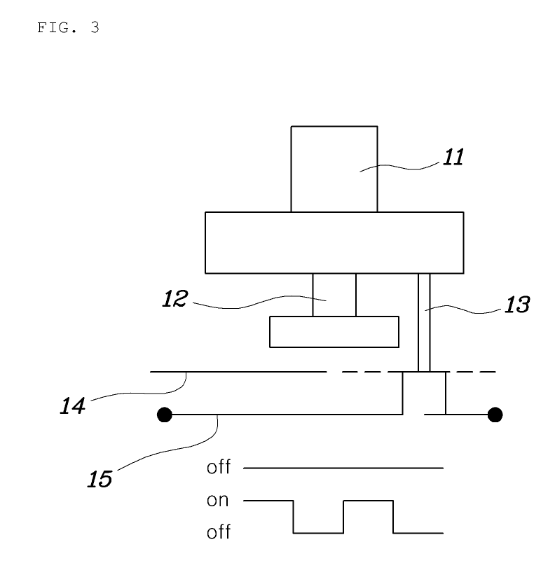

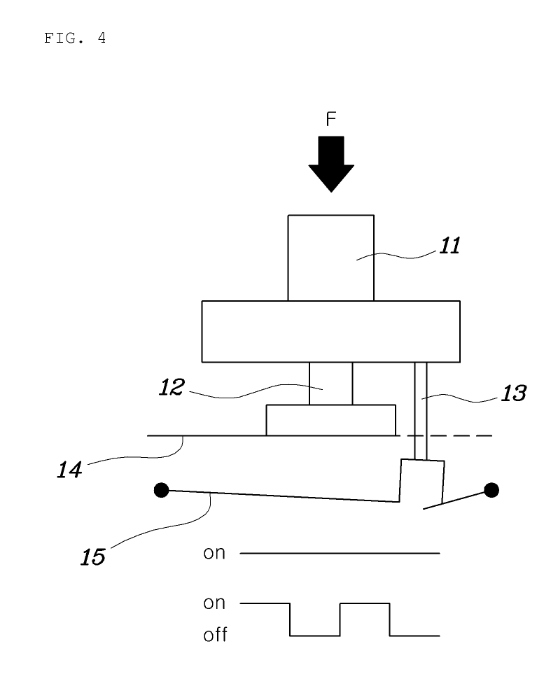

FIGS. 3 and 4 are views illustrating preferred operational principles of the rotary switching device, having two operational modes, according to the present invention for respective modes. Referring to FIG. 3, in certain exemplary embodiments, when the rotary push button 11 enters the first mode, in which the rotary push button 11 is not pushed, the first operational signal, which is suitably generated by the rotary switching device, is in an OFF state, and the second operational signal, which is suitably generated by the rotary switching device, is a square wave signal. In other preferred embodiments, when the rotary push button 11 enters the second mode, in which the rotary push button 11 is preferably pushed, referring to FIG. 4, the first operational signal, which is generated by the rotary switching device, is in an ON state, and the second operational signal, which is generated by the rotary switching device, is a square wave signal.

Accordingly, the first mode and the second mode can be suitably distinguished from each other. In preferred embodiments of the invention as described herein, a system can perform different operations using the modes.

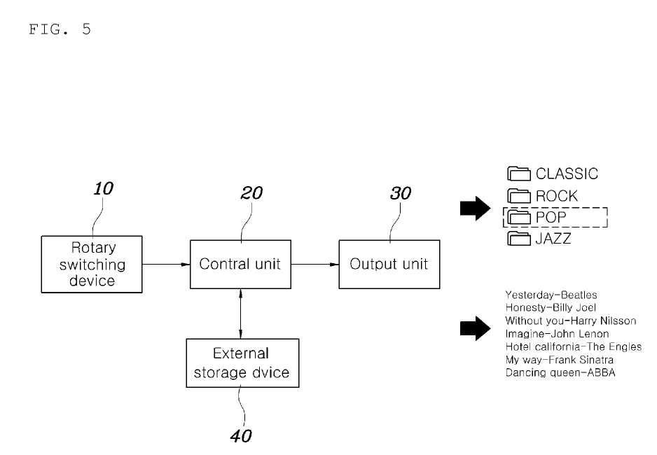

FIG. 5 is an exemplary conceptual block diagram showing a preferred file search system using the rotary switching device, having two operational modes, according to certain preferred embodiments of the present invention. Referring to FIG. 5, the file search system according to the present invention may preferably include a rotary switching device having two operational modes 10, a control unit 20, and an output unit 30.

The rotary switching device 10 having two operational modes has been described herein.

According to preferred embodiments of the invention as described herein, the control unit 20 preferably performs a file or folder search command, which is suitably recorded in a storage device, by combining a first operational signal and a second operational signal, which are suitably generated in two operational modes of the rotary switching device 10 (that is, a first mode and a second mode), and generates a resultant output signal.

For example, in further embodiments, when the first operational signal is in an OFF state and when a square wave signal is preferably input as the second operational signal, the control unit 20 suitably performs a folder search in such a way as to determine that the rotary switching device 10 has entered the first mode, in which the rotary switching device 10 is not pushed, and to check the rotated position of the rotary switching device 10. In other embodiments, when the first operational signal is preferably in an ON state and when the second operational signal is suitably input as the square wave signal, the control unit 20 performs a file search in such a way as to suitably determine that the rotary switching device 10 has entered the second mode, in which the rotary switching device 10 is pushed, and in thus in further related embodiments, to check the rotated position of the rotary switching device 10.

Preferably, the storage device may be a storage medium, for example, but not limited only to, Random Access Memory (RAM), which is provided in the control unit 20, an external storage medium 40, for example, but not limited only to, USB memory, or an SD card, which is externally connected.

In related embodiments, the output unit 30 is preferably constructed using a Liquid Crystal Display (LCD) device or the like, and suitably displays output information, which is transmitted from the control unit 20, to the outside.

According to certain preferred embodiments of the present invention, folders and files can be freely searched using a single rotary switching device, which can be rotated in two operational modes, so that the convenience of searching is suitably increased. Furthermore, no additional button is necessary, and thus the manufacturing costs can be suitably reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-6. (canceled)

7. A file search system, comprising:
a rotary switching device having two operational modes, the rotary switching device comprising: a rotary push button configured to be rotated both in a first mode and in a second mode, the first mode being a mode in which the rotary push button is rotated in a state in which the rotary push button is not pushed, and the second mode being a mode in which the rotary push button is rotated in a state in which the rotary push button is pushed;
a control unit for performing a file or folder search command, which is recorded in a storage device, by combining the first and second modes, and generating resultant output information; and
an output unit for displaying the output information, which is transmitted from the control unit.

8. The file search system as set forth in claim 7, wherein the rotary switching device includes a first switch part provided in one region of a lower surface of the rotary push button, and second switch parts provided in another region in the lower surface of the rotary push button, and a first contact part brought into contact with the first switch part in the second mode, thus generating a first operational signal, and a second contact part brought into contact with the second switch parts both in the first mode and in the second mode, thus generating a second operational signal.

9. The file search system as set forth in claim 8, wherein the first switch part is provided in a central region of the lower surface of the rotary push button.

10. The file search system as set forth in claim 8, wherein the second switch parts are provided in an outer circumferential region of the lower surface of the rotary push button.

11. The file search system as set forth in claim 10, wherein the second switch parts, which are provided in the outer circumferential region of the lower surface of the rotary push button, are concentrically formed at regular intervals.

12. The file search system as set forth in claim 11, wherein the second operational signal is a square wave signal, which is generated by rotation of the rotary push button and is configured to have a predetermined period.

13. The file search system as set forth in claim 8, wherein the second contact part is fastened using a member having elasticity so that the second contact part is brought into contact with the second switch parts in the second mode.

14. The file search system as set forth in claim 8, wherein the storage device is an external storage medium that is externally connected to the control unit.

15-19. (canceled)
